(19) United States
(12) Patent Application Publication
(10) Pub. No.: US 2023/0392612 A1
(43) Pub. Date: Dec. 7, 2023

(54) Coupling Unit with Thermal Separation Effect

(71) Applicant: KSB SE & Co. KGaA, Frankenthal (DE)

(72) Inventors: Axel SCHUNK, Frankenthal (DE); Tobias SECKINGER, Frankenthal (DE)

(21) Appl. No.: 18/031,964

(22) PCT Filed: Oct. 14, 2021
(86) PCT No.: PCT/EP2021/078401

§ 371 Date: Apr. 14, 2023

(30) Foreign Application Priority Data
Oct. 16, 2020 (DE) 10 2020 006 363.2
Oct. 13, 2021 (DE) 10 2021 005 120.3

(51) Int. Cl. F04D 29/58; F04D 29/42; F04D 29/62; F04D 13/06

(52) U.S. Cl. CPC F04D 29/5893; F04D 29/42; F04D 29/62; F04D 13/06

(57) ABSTRACT

A pump assembly includes a coupling unit which connects a pump casing to a motor casing. The coupling unit includes at least one thermal barrier which inhibits heat conduction between the pump casing and the motor casing.

### CROSS REFERENCE TO RELATED APPLICATIONS

This application claims priority under 35 U.S.C. § 119 from German Patent Application No. 102021005120.3, filed Oct. 13, 2021, and 102020006363.2, filed Oct. 16, 2020, the entire disclosures of which are herein expressly incorporated by reference.

### BACKGROUND AND SUMMARY OF THE INVENTION

The invention relates to a pump arrangement having a coupling unit which connects a pump housing and a motor housing to each other.

Such a pump arrangement may, for example, be a centrifugal pump arrangement. Centrifugal pumps are based on the operating principle of energy transmission to a fluid by means of changing torsion as a result of a torque which is brought about by a constantly rotating impeller on the fluid flowing through it.

In most cases, centrifugal pumps are driven by means of electric motors. In addition to this electric drive, in centrifugal pump technology piston force machines are also used as a drive. In this instance, electric motors produce a constant torque. The electric motor is an electromechanical energy converter which converts electrical energy into mechanical energy. Depending on the form in which the electrical energy is available, direct-current motors, alternating-current motors or three-phase current motors are used. Generally, the electrical energy is converted into a rotational movement in this instance.

The electric motor which drives a centrifugal pump is in most cases connected to the pump with a specific spacing by means of a coupling unit. The motor drive shaft extends in this instance centrally through openings in the two flanges or covers for securing to the motor and to the pump housing. Coupling units are generally produced by means of casting.

Such a coupling unit and a corresponding production method are, for example, described in EP 1 038 611 A2. The type and number of the described connection webs enable a particularly stable embodiment of a coupling unit.

In pump arrangements which are used to convey fluids at high temperatures, a high thermal input from the pump housing in the direction toward the electric motor may occur. This can lead to several problems with the electric motor. High temperatures reduce the degree of efficiency of the energy conversion. The components of the motor, in particular the windings of the stator and the rotor, are thermally loaded, whereby the service-life thereof can be shortened. The electric motor control may potentially reduce the power consumption and the speed in order to prevent overheating of the electric motor, whereby the pump can no longer operate in the desired operating range.

An object of the invention is to provide a coupling unit as a connection element between the pump housing and drive motor. This connection element should conduct the heat, which is emitted when conveying hot fluids from the pump housing, in the direction toward the motor as little as possible. Furthermore, the connection element should be characterized by a compact construction type. The exchange of replacement components should be promoted by the construction of the connection element. The connection element should be able to be produced in a simple and cost-effective manner.

This object is achieved according to the invention by a pump arrangement having a coupling unit having the features of claim 1. Preferred variants can be derived from the dependent claims, the description and the drawings.

According to the invention, at least one thermal conduction barrier is arranged inside the coupling unit. Such a thermal conduction barrier is particularly advantageous in order to thermally decouple a pump housing through which a hot fluid flows from the drive motor. This protects in particular the motor and the components which are installed therein and achieves the operation of the pump in the desired operating range.

Ideally at least one thermal conduction barrier is arranged in all the central axial sections. A thermal decoupling of the pump housing from the motor housing is thereby achieved since the heat cannot be conducted over a direct axial connection between the housings.

Advantageously, such a thermal conduction barrier is in the form of a material recess. The space of a material recess generally takes in air which is known to be a particularly good insulator and consequently constitutes a barrier for the thermal conduction. In an alternative variant of the invention, such a thermal conduction barrier could also be in the form of a particularly poorly thermally conductive material, such as, for example, a material based on ceramic material.

According to the invention, the coupling unit directly connects the pump housing and the motor housing. In principle, no other component is required to produce this connection. A reduction of the component number is in most cases advantageous for the reduction of the production costs.

The coupling unit is preferably constructed in a cylindrical and/or trumpet-funnel-like manner. The spatial construction is particularly advantageous in order to achieve an additional cooling of the coupling unit by the cool air flow which is produced by the motor fan. In an alternative variant of the invention, the coupling unit may also be constructed in a conical and/or parallelepipedal manner.

In a variant of the invention, the coupling unit is constructed integrally with the motor-side pressure cover of the pump housing and/or integrally with the pump-side motor cover. Advantageously, the coupling unit can consequently be configured in a particularly compact manner and enables a pump arrangement with dimensions which can also be used at installation locations with limited spatial relationships.

According to the invention, the thermal conductivity of the coupling unit material is less than 400 W/m·K, preferably less than 300 W/m·K, in particular less than 250 W/m·K, and/or more than 10 W/m·K, preferably more than 20 W/m·K, in particular more than 30 W/m·K. Preferably, the coupling unit is produced from grey cast iron or aluminum using casting methods.

Ideally, the thermal conductivity of the thermal conduction barrier is less than 20 W/m·K, preferably less than 15 W/m·K, in particular less than 10 W/m·K, and/or more than 0.002 W/m·K, preferably more than 0.05 W/m·K, in particular more than 0.1 W/m·K.

According to the invention, the width of the material recess is more than mm, preferably more than 1 mm, in particular more than 1.5 mm, and/or less than 30 mm, preferably less than 25 mm, in particular less than 20 mm. Advantageously, the material thickness of the coupling unit is more than 1 mm, preferably more than 2 mm, in particular more than 3 mm, and/or less than 14 mm, preferably less than 12 mm, in particular less than 10 mm. The coupling unit according to the invention is characterized by a slim construction type with a manageable material use with at the same time a stable and vibration-resistant construction.

According to the invention, the coupling unit is constructed at the pump side and/or motor side as a bearing carrier. This leads to a particularly compact construction of the coupling unit and at the same time to the reduction of the assembly complexity by reducing the number of components.

The coupling unit according to the invention is characterized by a compact, axial construction type in which the entire path of the thermal conduction is extended by the insertion of material recesses.

Other features and advantages of the invention will be appreciated from the description of embodiments with reference to the drawings and from the drawings themselves.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a section through a centrifugal pump unit in accordance with an embodiment of the present invention,

FIG. 2 shows a perspective illustration of a coupling unit in accordance with an embodiment of the present invention,

FIG. 3 shows a perspective illustration of another coupling unit construction in accordance with an embodiment of the present invention,

FIG. 4 shows a perspective illustration of a third coupling unit construction in accordance with an embodiment of the present invention,

FIG. 5 shows a perspective illustration of another coupling unit construction in accordance with an embodiment of the present invention.

### DETAILED DESCRIPTION

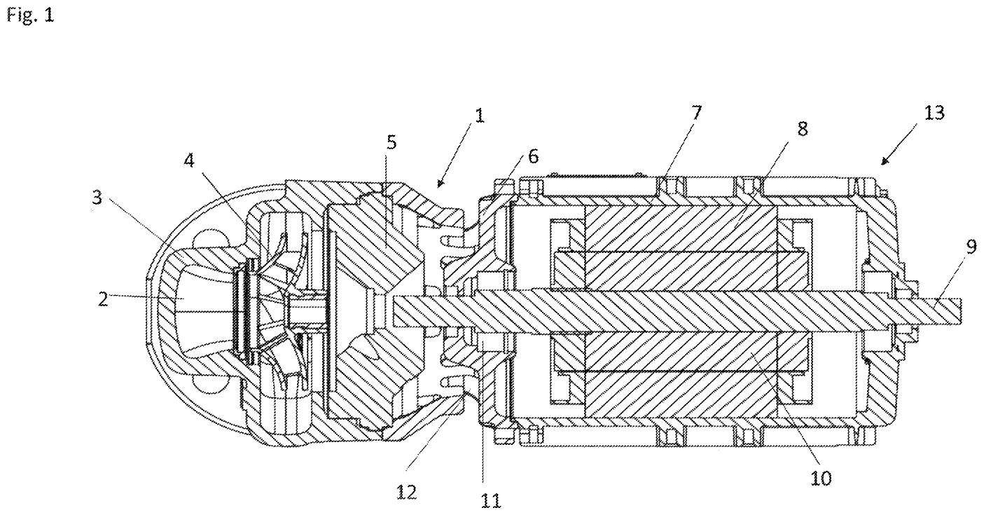

FIG. 1 shows a pump arrangement having a coupling unit 1 which connects a pump housing 3 and a motor housing 7 to each other. The centrifugal pump illustrated in the embodiment is used to convey fluids which under some circumstances may have high temperatures.

The fluid enters the pump housing 3 of the centrifugal pump through a suction nozzle 2. The impeller 4 is arranged inside the pump housing 3. The impeller 4 transmits kinetic energy to the fluid which leaves the centrifugal pump via pressure nozzles which are not shown in this illustration. The space which is filled with fluid and the impeller 4 is delimited by a pump housing 3 and a housing cover 5. The impeller 4 is connected in a rotationally secure manner to a shaft 9 which drives the impeller 4 by means of a motor arrangement 13. The motor arrangement 13 comprises a rotor 10, a stator 8, the shaft 9, a pump-side motor cover 6 and a motor housing 7. A bearing carrier which carries a bearing 11 is arranged in the motor cover 6.

With reference to the illustration of the coupling unit 1 in FIG. 1, it can clearly be seen that in all the central axial portions a thermal conduction barrier 12 is produced between the pump housing 3 and the motor housing 7. Such a thermal conduction barrier 12 is in such a form that no direct axial connection exists between the housing components, which in turn more powerfully thermally decouples the housings 3 and 7. In this advantageous manner, the path of the thermal conduction is extended significantly in a radial direction without increasing the axial structural length of the coupling unit 1.

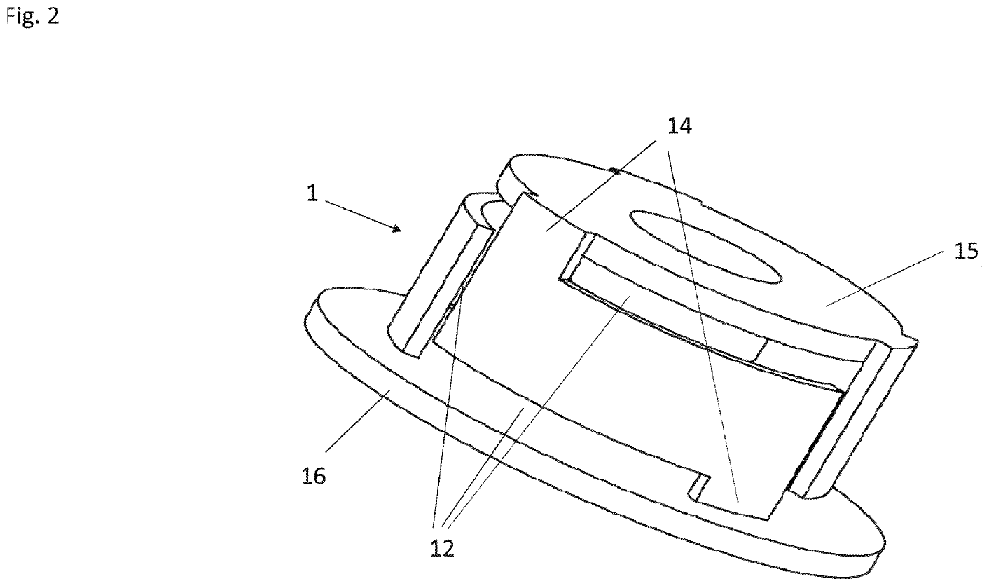

FIG. 2 shows a perspective illustration of a coupling unit 1. The connection plate 15 for connection to the motor cover 6 which is not shown in this instance is connected by means of connection webs 14 to the connection plate 16 in order to connect to the housing cover 5 (which is also not shown) of the pump housing 3. The coupling unit 1 has a plurality of thermal conduction barriers 12 which in this embodiment are in the form of material recesses. In an alternative variant, the thermal conduction barrier could also be in the form of a material which has poor thermal conductivity. The connection webs 14 prevent engagement in the rotating shaft 9. The structural configuration of the connection webs 14 produces a coupling unit 1 which provides with the shortest possible axial structural space an extremely long circumferential path of the thermal conduction. The cooling air flow which is produced by the motor fan which is not illustrated and which flows via the cooling ribs of the motor housing 7 in the direction toward the coupling unit 1 can in addition to the thermal conduction barrier 12 discharge the heat which is conducted by the connection webs 14 from the pump housing 3 so that an extremely small thermal input arrives at the motor cover 6. As a result of the particularly advantageous construction of the coupling unit 1, the pump housing 3 and the motor arrangement 13 are more powerfully thermally decoupled.

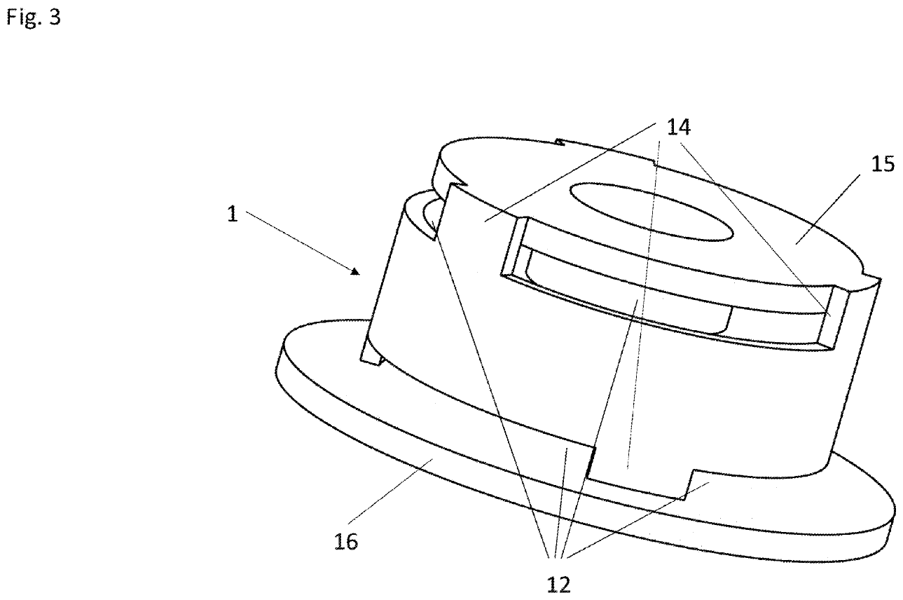

FIG. 3 shows a perspective illustration of another embodiment of the coupling unit 1. The connection plate 15 for connection to the motor cover 6 which is not illustrated in this instance is connected by means of connection webs 14 to the connection plate 16 for connection to the housing cover 5 (which is also not illustrated) of the pump housing 3. The coupling unit 1 has a plurality of thermal conduction barriers 12 which in this embodiment are in the form of material recesses. In this variant of the invention, the connection webs 14 are in the form of a cylindrical component which by means of four small connection elements are in each case constructed integrally with the connection plates 15 and 16. The material recesses are in each case arranged between the small connection elements and between the cylindrical component and the connection plate 16 and the cylindrical component and the connection plate 15. Advantageously, by means of this variant of the connection unit 1, the motor arrangement 13 is thermally decoupled from the pump housing 3 and, at the same time, the coupling unit 1 is configured in a particularly stable and vibration-resistant manner.

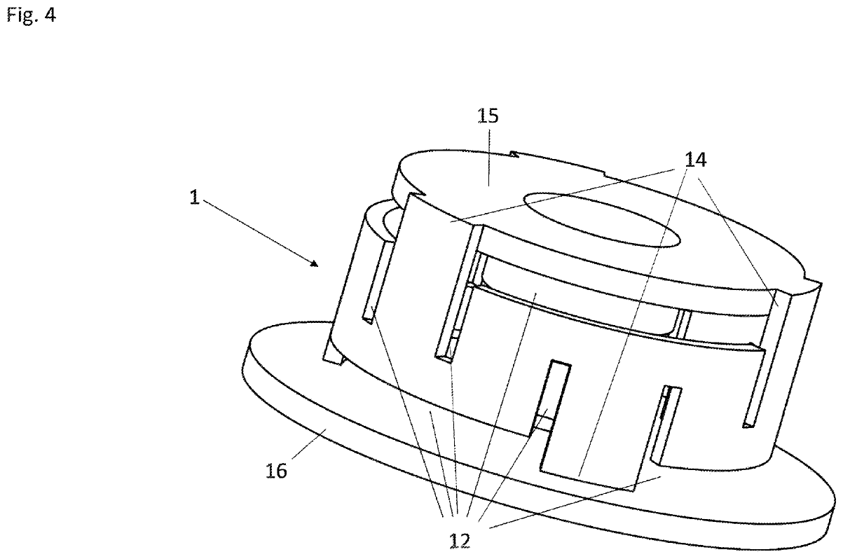

FIG. 4 shows a perspective illustration of a third variant of the coupling unit 1 according to the invention. The connection plate 15 for connection to the motor cover 6 which is not illustrated here is connected by means of connection webs 14 to the connection plate 16 for connection to the housing cover 5 (which is also not illustrated) of the pump housing 3. The coupling unit 1 has a large number of thermal conduction barriers 12 which in this embodiment are in the form of material recesses. The coupling unit 1 of FIG. 4 corresponds to the coupling unit 1 of FIG. 3. In this instance, in addition, the cylindrical component is provided with additional axially arranged thermal conduction barriers 12 in the form of material recesses. The radial and/or axial extent of the thermal conduction from the pump housing 3 in the direction of the motor arrangement 13 is thereby extended without increasing the axial length of the coupling unit 1.

In this instance, the thermal conductivity of the coupling unit material is less than 400 W/m·K, preferably less than 300 W/m·K, in particular less than 250 W/m·K, and/or more than 10 W/m·K, preferably more than 20 W/m·K, in particular more than 30 W/m·K. The thermal conductivity of the thermal conduction barrier 12 is in this instance less than 20 W/m·K, preferably less than 15 W/m·K, in particular less than 10 W/m·K, and/or more than W/m·K, preferably more than 0.05 W/m·K, in particular more than 0.1 W/m·K.

The width of the thermal conduction barrier 12 which in this embodiment is in the form of a material recess is more than 0.5 mm, preferably more than 1 mm, in particular more than 1.5 mm, and/or less than 30 mm, preferably less than 25 mm, in particular less than 20 mm. The material thickness of the coupling unit 1 is more than 1 mm, preferably more than 2 mm, in particular more than 3 mm, and/or less than 14 mm, preferably less than 12 mm, in particular less than 10 mm.

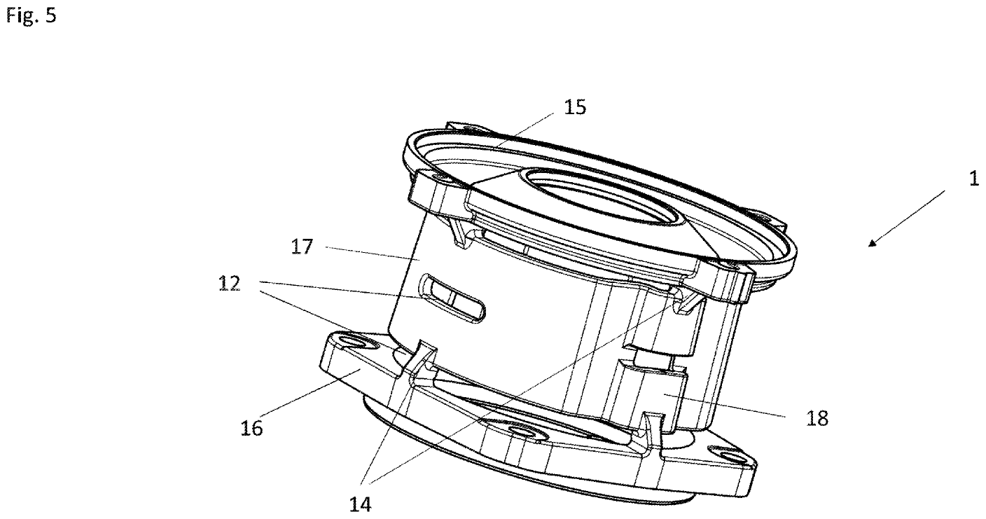

FIG. 5 shows a perspective illustration of a coupling unit 1. The connection plate 15 for connection to the motor cover 6 which is not illustrated here is connected by means of connection webs 14 via a hollow-cylindrical sleeve 17 and additional connection webs 14 to the connection plate 16 for connection to the housing cover 5 (which is also not illustrated) of the pump housing 3.

The connection unit 1 has a plurality of thermal conduction barriers 12 which in this embodiment are in the form of material recesses. In an alternative variant, the thermal conduction barrier could also be made from a material with poor thermal conductivity. The connection webs 14 and the hollow-cylindrical sleeve 17 prevent an engagement in the rotating shaft 9 and direct from the motor housing 7 into the base of the pump the forces which act through the mass of the motor arrangement 13. To this end, the hollow-cylindrical sleeve 17 is additionally reinforced around two recesses 18 in the embodiment shown.

The thermal conduction barriers 12 which are arranged beside the connection webs 14 limit the thermal conduction to a minimum and extend the path of the thermal conduction from the connection plate 16 in the direction of the connection plate 15, in particular as a result of the radially inwardly orientated extent of the connection webs 14.

The parallelepipedal connection plate 16 is constructed with rounded edges, wherein the connection webs 14 begin in each case centrally and extend radially inward in the manner of a strut. The hollow-cylindrical sleeve 17 has additional thermal conduction barriers 12 in the form of material recesses which lead to an extended path of the thermal conduction and thereby virtually thermally decouple the pump housing 3 and the motor housing 7.

The cooling air flow which is produced by the motor fan which is not illustrated and which flows over the cooling ribs of the motor housing 7 in the direction toward the coupling unit 1 can in addition to the thermal conduction barriers 12 discharge the heat which is conducted by the connection webs 14 from the pump housing 3 so that an extremely low thermal input arrives at the motor cover 6.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-13. (canceled)

14. A pump arrangement, comprising:
a pump housing;
a motor housing; and
a coupling unit configured to connect the pump housing and the motor housing to each other,
wherein the coupling unit includes at least one thermal conduction barrier.

15. The pump arrangement as claimed in claim 14, wherein
the at least one thermal conduction barrier includes at least one thermal conduction barrier between the pump housing and the motor housing at all axial sections of the coupling unit.

16. The pump arrangement as claimed in claim 14, wherein
the thermal conduction barrier is a material recess.

17. The pump arrangement as claimed in claim 14, wherein
the coupling unit directly connects the pump housing and the motor housing.

18. The pump arrangement as claimed in claim 14, wherein
a shape of the coupling unit include one or more of a cylindrical shape, a trumpet-funnel shape, a conical shape, and a shape of a body having a polygonal base face.

19. The pump arrangement as claimed in claim 14, wherein
the coupling unit is constructed integrally with a motor-side pressure cover of the pump housing.

20. The pump arrangement as claimed in claim 14, wherein
the coupling unit is constructed integrally with a pump-side motor cover.

21. The pump arrangement as claimed in claim 14, wherein
a thermal conductivity of the coupling unit material is at least one of less than 400 W/m·K and more than 10 W/m·K.

22. The pump arrangement as claimed in claim 21, wherein
the thermal conductivity of the coupling unit material is at least one of less than 250 W/m·K, and more than 30 W/m·K.

23. The pump arrangement as claimed in claim 14, wherein
a thermal conductivity of the thermal conduction barrier is at least one of less than 20 W/m·K and more than 0.1 W/m·K.

24. The pump arrangement as claimed in claim 23, wherein
the thermal conductivity of the thermal conduction barrier is at least one of less than 10 W/m·K and more than 0.1 W/m·K.

25. The pump arrangement as claimed in claim 16, wherein
a width of the material recess is at least one of more than 0.5 mm and less than 30 mm.

26. The pump arrangement as claimed in claim 25, wherein
the width of the material recess is at least one of more than 1.5 mm and less than 20 mm.

27. The pump arrangement as claimed in claim 14, wherein
a material thickness of the coupling unit is at least one of more than 1 mm and less than 14 mm.

28. The pump arrangement as claimed in claim 27, wherein
the material thickness of the coupling unit is at least one of more than 3 mm and less than 10 mm.

29. The pump arrangement as claimed in claim 14, wherein
the coupling unit formed as one or both of a pressure cover at a pump side of the coupling unit and a bearing carrier at a motor side of the coupling unit.

30. The pump arrangement as claimed in claim 14, wherein
a path for the thermal conduction includes a least one portion through which heat is conducted in a first axial direction and a circumferentially adjacent portion through which heat is conducted in a second axial direction opposite the first axial direction.
